(19) United States
(12) Patent Application Publication
(10) Pub. No.: US 2024/0105081 A1
(43) Pub. Date: Mar. 28, 2024

(54) 1SYSTEM AND METHOD FOR PROVIDING VISUAL SIGN LOCATION ASSISTANCE UTILITY BY AUDIBLE SIGNALING

(71) Applicant: AUDIBLE BRAILLE TECHNOLOGIES, LLC, SEASIDE, CA (US)

(72) Inventors: MICHAEL ROY CONOVER, SEASIDE, CA (US); ANTONIO SABAREZ, II, HOLLISTER, CA (US)

(73) Assignee: AUDIBLE BRAILLE TECHNOLOGIES, LLC, SEASIDE, CA (US)

(21) Appl. No.: 17/953,262

(22) Filed: Sep. 26, 2022

(51) Int. Cl. G09B 21/00; G08B 3/00

(52) U.S. Cl. CPC G09B 21/006; G08B 3/00; G09B 21/003

(57) ABSTRACT

A system and method are provided for utilizing a device positioned at or near a signage plate to provide non-visual assistance in approaching the signage plate's location when activated by a digital signal. A venue might improve accessibility by installing the invented device next to or even behind one or more restroom signs. A visitor using this accessibility feature might utilize a fob provided by the venue or a personal device such as a smartphone with a compatible app, such that the visitor can press a button and activate the invented device to generate a non-visual cue to assist the visitor in locating the device and associated sign, such as emitting an audio sound. The fob or phone might further provide additional guidance, such as emitting the same sound as the sign device so that the visitor knows what sound to listen for, or providing additional information.

### BACKGROUND OF THE INVENTION

### Field of the Invention

The field of invention pertains generally to accessibility utilities, and particularly to a system and method for providing non-visual assistance in locating features of interest.

### Background Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Public spaces such as museums, theaters, community centers, malls, and amusement parks continue to make strides in providing accessibility for all potential patrons and customers, including people who require accessibility assistance, such as the disabled community. Ramps providing wheelchair access, audio chirps at crosswalks, braille on signage for the visually impaired, sign language interpreters for the deaf, and speech-to-command and speech-to-text computer utilities are all known advancements in this field. It is known that improvement of accessibility is not merely providing of an optional ‘special feature’ that exclusively benefits those who require accommodation in order to participate at all, but a process of optimization that improves everyone's ability to access and enjoy public spaces and participate in society.

To name one specific instance in which accessibility can still be improved, one might consider a visually-impaired patron visiting a public venue, who is searching for a feature of the venue, such as a restroom. A sign posted on the wall beside the restroom door may include braille, but first, one must locate the sign or door at all, which could be all the way across a room. A sighted person would be able to see the sign even from across the room and approach the door easily, but someone who's visually-impaired might still have to ask for help to find the restroom door or sign at all; braille on the sign only helps once one locates the sign in the first place. Other common features of interest in a public venue, such as but not limited to a water fountain, a place to sit down, a help desk, a device charging station, an exit (including an emergency exit), might be similarly evident to a sighted person navigating the venue, but comparatively difficult for a visually-impaired person to locate and access, even with appropriate accessibility improvements as currently known in the art implemented within the venue.

There is, therefore, a long-felt need generally to improve accessibility and accommodation wherever these may be lacking, and specifically to improve utilities for aiding someone enjoying a public venue in non-visually locating amenities and features of interest within that venue.

### BRIEF SUMMARY OF THE INVENTION

Towards these and other objects of the method of the present invention (hereinafter, “the invented method”) that are made obvious to one of ordinary skill in the art in light of the present disclosure, what is provided is a system and method for utilizing a device positioned at or near a signage plate to provide non-visual assistance in approaching the signage plate's location when activated by a digital signal.

In certain preferred embodiments and applications, and utilizing the example of restroom signage as an obvious potential application, a venue might improve accessibility by installing the invented device next to or even behind one or more restroom signs. A visitor using this accessibility feature might be offered a fob, i.e. a small remote-control, upon entrance to the venue, such that the visitor can press a button and activate the invented device to generate a non-visual cue to assist the visitor in locating the device and associated sign, such as emitting an audio sound. The visitor might also access this feature of the venue via software on a mobile device, such as a smartphone app capable of detecting or interfacing with instances of the invented device. The fob or phone might further provide additional guidance, such as emitting the same sound as the sign so that the visitor knows what sound to listen for, or providing additional directions or information (such as a text description, i.e. “back toward the entrance, on your right”, which a visually-impaired person's phone could read to that user aloud). Still further convenient features might include the ability to further specify what kind of amenity is sought—continuing with the restroom example, one might further specify restroom gender, wheelchair accessibility, or other restroom features which might appear on signage such as a diaper-changing station. This preference might be specified by the user when searching, or might even be pre-set on the user's personal device; for instance, the phone may already have information such as the user's gender, and might personalize the query without relying on user guidance. Utilizing location features on the visitor's personal device, or detection of proximity between the sign device and the user's device, may also provide additional utility and convenience.

It is noted that broad variation in audio sounds generated as non-visual accessibility cues as utilized herein is possible, may provide further benefits, and also that some audio cues may be found to be more effective than others in this context. For instance, some studies have suggested better noises to utilize for a truck backing up warning instead of the usual ‘beep-beep-beep . . . ’, such as white noise bursts, because human participants were better able to locate by hearing alone which direction the tested noise originated from than they were able to correctly pinpoint the origin direction of a beep; auditory directionality might similarly be a factor here, and may be worth keeping in mind. The device might emit a single noise, may repeat the noise for a while so the user has time to follow the sound, or may play a whole pattern, such as a preset pattern identifying this specific sign in a venue containing more than one that might be activated at once, a Morse code phrase, a sound effect, or even a piece of music. It is noted that the volume level may also vary, in accordance with the venue; a club or loud concert may have to play accessibility noises loud to be effective, but a quiet museum or library might play accessibility noises soft. Different venues might make aesthetic choices regarding their accessibility noises, such as to ‘blend in’ with (a little, but not entirely) or ‘match’ the ambiance of the rest of the setting rather than jar or annoy other patrons, or even to match the theme of the venue (for instance, an amusement park might set the sound to be a themed character voice calling out, ‘Restrooms are over here!’). It is noted that, particularly in the absence of providing a feature of playing the sound back to the visitor so the visitor knows what sound to listen for, some kind of standard or convention as to what sort of noise is generally used, such that someone who uses the feature often would recognize a pattern directed to this purpose as opposed to an unrelated audio cue like somebody's ringtone in a crowded room, may be useful also.

Certain alternate preferred embodiments of the invented system include (a.) a fixed device comprising a control logic communicatively coupled with a fixed wireless communications module, an audio emitter, and a power source, the power source coupled with and providing electrical power to the control logic, the fixed wireless communications module and the audio emitter; (b). a signage plate coupled with the fixed device coupled with, the signage plate visually signifying a physical resource, and the signage plate positioning the fixed device, (c.) a mobile device comprising a mobile control logic communicatively coupled with a mobile wireless communications module and a user input module and a battery, the battery providing electrical power to the mobile control logic, the mobile wireless communications module and the user input module, wherein the control logic is configured to emit a search signal via the mobile wireless communications module upon detection by the user input module of a user search command, wherein the fixed device is configured to emit an audible output via the audio emitter upon detection of the search signal.

It is understood that the terms configured as defined in this disclosure includes the ranges of meaning as known in the art of programmed, reprogrammed, reconfigured, designed to, and adapted to.

In certain still alternate preferred embodiments of the invented method, the signage plate conforms to Chapter 7 COMMUNICATION ELEMENTS AND FEATURES and/or Section 703 SIGNS of the “2010 ADA Standards for Accessible Design”, published on Sep. 15, 2010, by the United States Department of Justice.

Certain additional alternate preferred embodiments of the invented method include one or more of the following aspects: (1.) the fixed device being configured to repeatedly emit the audible output via the audio emitter upon detection of the search signal; (2.) the fixed device audible output is a single tone pattern; (3.) wherein the audible output comprises an audible tone pattern that comprises at least two distinguishable tones; (4.) the fixed device audible tone pattern is associated with a pre-established meaning; (6.) the audible output comprises a plurality of audible tone patterns; (7.) each audible tone pattern of the plurality of audible tone patterns is separately associated with a distinguishable pre-established meaning; (8.) the mobile device control logic being further configured to emit a cessation signal via the mobile wireless communications module upon detection by the user input module of a sound cessation input command; (9.) the audible output is associated with an aspect of the physical resource. (10) the fixed device being further configured to cease emitting the audible output upon receipt of the cessation signal; (11.) the fixed device further comprising a countdown timer coupled with the control logic, and the control logic is further configured to initiate the countdown timer process upon receipt of the search signal and to cease emitting the audible signal upon a completion of the countdown timer process; (12.) the mobile device further comprises a mobile audio output coupled with the control device and the mobile audio output is configured to emit a local audible output matching the audible output of the fixed device; (13.) the audible output comprises at least two successive and distinguishable sounds; (14.) the physical resource comprises at least one lavatory fixture; (15.) signage plate presents a pattern of raised dots that are scaled, sized and positioned to be felt by human fingertips; (16.) the signage plate presents a pattern of raised dots that conform to aspects of a braille system of written language; (17.) audible output is emitted within a sound intensity range of from 20 decibels to 120 decibels; (18.) the user input module is adapted to detect and execute a verbal search instruction command; (19.) the user input module is adapted to detect and execute at least two verbal search instruction commands, wherein each verbal search command is formed in a separate and distinguishable human language; (20.) wherein the user input module comprises a touch sensor adapted to detect and execute a search instruction command indicated by finger pressure; (21) the user input module comprises a touch sensor adapted to detect and execute a search instruction command indicated by human body heat; (22.) wherein the search signal includes information associated with the mobile device; (23.) wherein the search signal includes information associated with a user of the mobile device; (24.) wherein the search signal includes an identifier that directs a selection by the fixed device of the audible output; (25) wherein the fixed device includes a memory element coupled with the controller and the controller is further configured to record an aspect of an interaction with the mobile device; (26.) the fixed device includes a programmable memory element bidirectionally communicatively coupled with the controller and the controller is to receive reprogramming instructions via the wireless communications module and store the reprogramming instructions in the programmable memory, whereby the fixed device is reprogrammed; (27.) wherein the mobile device user input module further comprises a microphone and a speech-to-command logic coupled with the microphone and the mobile control logic, wherein the speech-to-command logic is configured derive of machine-executable commands from audio signals generated by the microphone and deliver the derived machine-executable commands to the mobile control logic; (28.) wherein the mobile device user input is further communicatively coupled with the mobile wireless communications module, and the speech-to-command logic is further configured to communicate audio signals received via the microphone to a remote server via the mobile wireless communications module, and the mobile device user is further configured receive at least one derived machine-executable command via the mobile wireless communications module and to deliver the at least one derived machine-executable command to the mobile control logic; and/or (29.) a server comprising a remote speech-to-command logic, the speech-to-command logic configured to derive machine-executable commands from audio signals, a microphone coupled with the mobile control logic; and the mobile device user input is coupled with a speech-to-command logic and the microphone, wherein the mobile device user input is further communicatively coupled with the mobile wireless communications module, and the speech-to-command logic is further configured to communicate audio signals received from the microphone to the remote server via the mobile wireless communications module, and the mobile device user is further configured receive at least one derived machine-executable command via the mobile wireless communications module from the remote server and to deliver the at least one derived machine-executable command to the mobile control logic.

Certain yet alternate preferred embodiments of the invented method include one or more of the following aspects: (1.) positioning a fixed device coupled with a signage plate relative to a physical resource, the fixed device comprising a control logic communicatively coupled with a fixed wireless communications module and an audio emitter, and a power source, the power source coupled with and providing electrical power to the control logic, the fixed wireless communications module and the audio emitter; (2.) fixed device detecting a preset search signal received via the fixed wireless communications module; and (3.) the fixed device thereupon emitting an audible output upon receipt preset search signal, wherein the audible output indicates an aspect of the physical resource.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and/or patent applications mentioned in this specification are herein incorporated by reference to the same extent as if each individual publication, patent, or patent application was specifically and individually indicated to be incorporated by reference.

The present disclosure incorporates by reference the following publications, patents, and/or patent applications, in their entirety and for all purposes, including U.S. Pat. No. 10,846,957 B2 (Inventors: Cheng, S. Y. T., et al., issued on Nov. 24, 2020) and titled WIRELESS ACCESS CONTROL SYSTEM AND METHODS FOR INTELLIGENT DOOR LOCK SYSTEM U.S. PATENT DOCUMENTS; U.S. Pat. No. 9,510,159 B1 (inventors Cuddihy, M. A., et al., issued on Nov. 29, 2016 and titled DETERMINING VEHICLE OCCUPANT LOCATION; U.S. Pat. No. 10,548,380B2 (Inventors RAYNOR, G. A. et al., issued on Feb. 4, 2020) and titled WATERPROOF HOUSING FOR AN ELECTRONIC DEVICE; U.S. Pat. No. 9,624,711 (Inventor McAlexander, C. D., issued on Apr. 18, 2017) and titled LOCKING INSERT MECHANISM AND RECEIVER TO SECURE PERSONAL WEAPONS, VALUABLES AND OTHER ITEMS; and “2010 ADA Standards for Accessible Design”, published on Sep. 15, 2010 by the United States Department of Justice.

The above-cited publications, patents, and/or patent applications are incorporated herein by reference in their entirety and for all purposes.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 is a diagram presenting an electronic communications network pertaining to practice of an invented system and method;

FIG. 2A is a block diagram presenting hardware and software aspects of the fixed device of FIG. 1;

FIG. 2B is a block diagram presenting hardware and software aspects of the mobile device of FIG. 1;

FIG. 2C is a block diagram presenting hardware and software aspects of the mobile fob of FIG. 1;

FIG. 3A is a flow chart presenting in combination with FIG. 3B a first version of an invented method, from the mobile device or fob of FIG. 1 (user) side;

FIG. 3B is a flow chart presenting in combination with FIG. 3A a first version of an invented method, from the fixed device of FIG. 1 (sign) side;

FIG. 4A is a flow chart presenting in combination with FIG. 4B a second version of an invented method, from the mobile device or fob of FIG. 1 (user) side;

FIG. 4B is a flow chart presenting in combination with FIG. 4A a second version of an invented method, from the fixed device of FIG. 1 (sign) side;

FIG. 5A is a flow chart presenting in combination with FIG. 5B a third version of an invented method, from the mobile device or fob of FIG. 1 (user) side;

FIG. 5B is a flow chart presenting in combination with FIG. 5A a third version of an invented method, from the fixed device of FIG. 1 (sign) side;

FIG. 6A is a flow chart presenting in combination with FIG. 6B a fourth version of an invented method, from the mobile device or fob of FIG. 1 (user) side;

FIG. 6B is a flow chart presenting in combination with FIG. 6A a fourth version of an invented method, from the fixed device of FIG. 1 (sign) side;

FIG. 7 is a flow chart presenting options for selection and production of an audio cue by the fixed device of FIG. 1, for use in practicing an invented method; and

FIG. 8 is a flow chart presenting options for composition and sending of a request signal by the mobile device of FIG. 1, for use in practicing an invented method.

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs.

Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.)

Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system.

Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

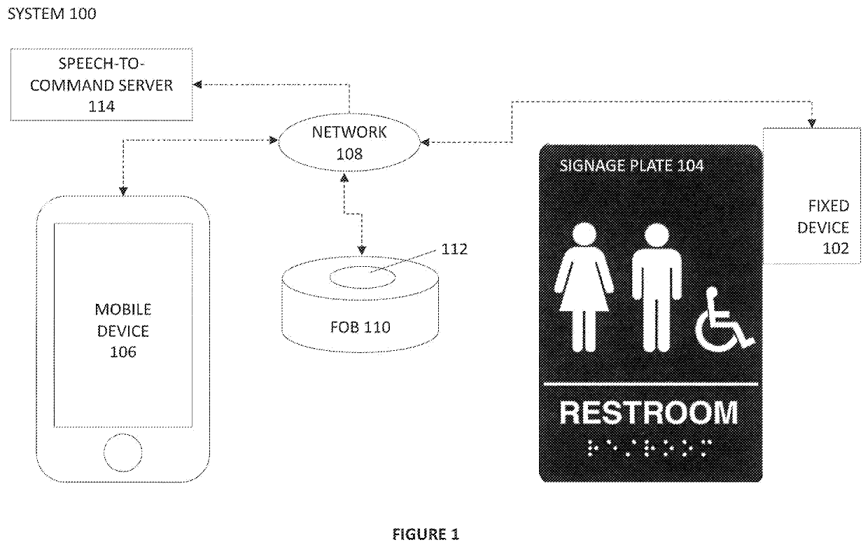

Referring now generally to the Figures, and particularly to FIG. 1, FIG. 1 is a diagram presenting an invented system (“the system 100”) incorporating a fixed device 102 coupled with or positioned close to a signage plate 104 which may include elements such as icons, text, or braille signifying the location of a certain feature of interest, such as, in this example, a restroom. A user, such as an individual looking for the restroom associated with the signage plate 104 who can't effectively see the signage plate 104, might interface with the fixed device 102 by utilizing: (a.) a mobile device 106, such as the user's personal smartphone or similar, bi-directionally communicatively coupled to the fixed device 102 via an electronic communications network 108; and/or (b.) a fob 110 having an input element 112 and bi-directionally communicatively coupled to the fixed device 102 via the electronic communications network 108. The user might operate the input element 112 on the fob 110 (such as but not limited to pressing a button) or utilize an app on the mobile device 106 to activate the fixed device 102 to provide non-visual assistance to guide the user toward the associated restroom, such as with played audio. The network 108 may further include a speech-to-command server 114 as a utility for any accessibility element that may require access to speech-to-command resources, such as the mobile device 106.

The signage plate 104 preferably conforms to Chapter 7 COMMUNICATION ELEMENTS AND FEATURES and/or Section 703 SIGNS of the “2010 ADA Standards for Accessible Design”, published on Sep. 15, 2010, by the United States Department of Justice.

It is to be understood that one or more elements or the entire the fixed device 102 may be attached to the signage plate 104, or to a door to which the signage plate 104 is attached, or to any suitable structural element preferably located within six meters to the signage plate 104, in any suitable manner known in the art. For instance, the one or more elements of the fixed device 102, or the entire fixed device 102, may be attached to the signage plate 104 through a corresponding snap interface a corresponding clip interface, corresponding hinge interfaces, a snap interface, an adhesive interface, a fastener and receiver assembly, a hook and loop interface, a bolt or rivet interface, a slide and catch interface, and/or other suitable attachment means known in the art. Alternatively a suitable attachment mechanism for coupling the one or more elements of the fixed device 102, or the entire fixed device 102, to the signage plate 104, a door, and/or another fixed structural element may be or comprise an external clip, a clamp, a band or a fastener, such as a hook and loop fastener, or adhesive, a combination of the same and/or other suitable attachment systems known in the art.

It is further noted that, in certain alternate preferred embodiments of the method of the present inventions, the network 108 enables, and the fixed device 102, the fob 110, and/or the mobile device 108 are configured to communicate via or in accordance with (a.) the BLUETOOTH™ short-range wireless technology as provided by the BLUETOOTH SPECIAL INTEREST GROUP of Kirkland, Washington; (b.) the IEEE 802.11 promoted as a Wi-Fi™ wireless communications standard promoted by the non-profit Wi-Fi Alliance of Austin, TX; (c.) Radio Frequency Identification (“RFID”) communications protocol RAIN RFID as regulated by the global standard EPC UHF Gen2v2 or ISO/IEC 18000-63 as promoted by the RAIN RFID Alliance of Wakefield, MA; (d.) other suitable electronic communications standards modules known in the art, in singularity, plurality or suitable combination.

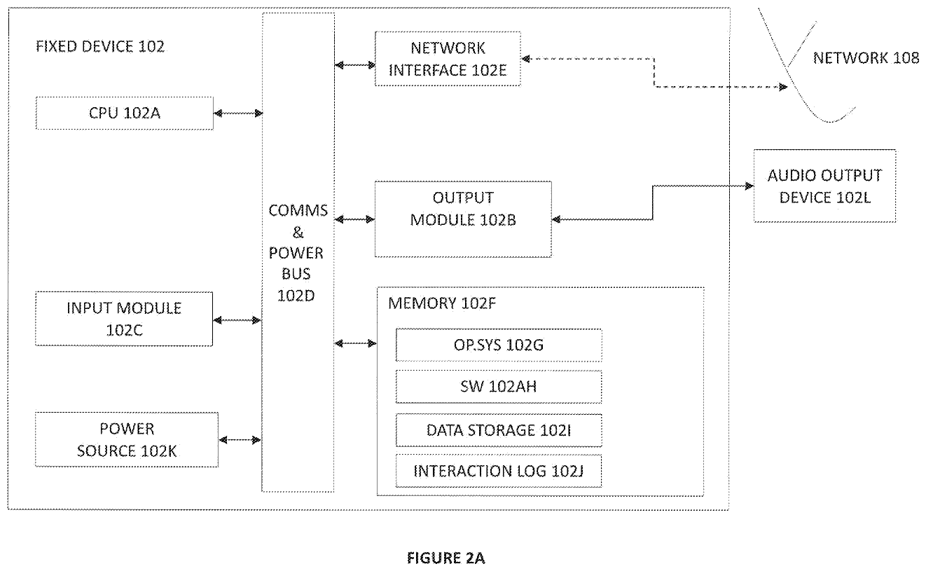

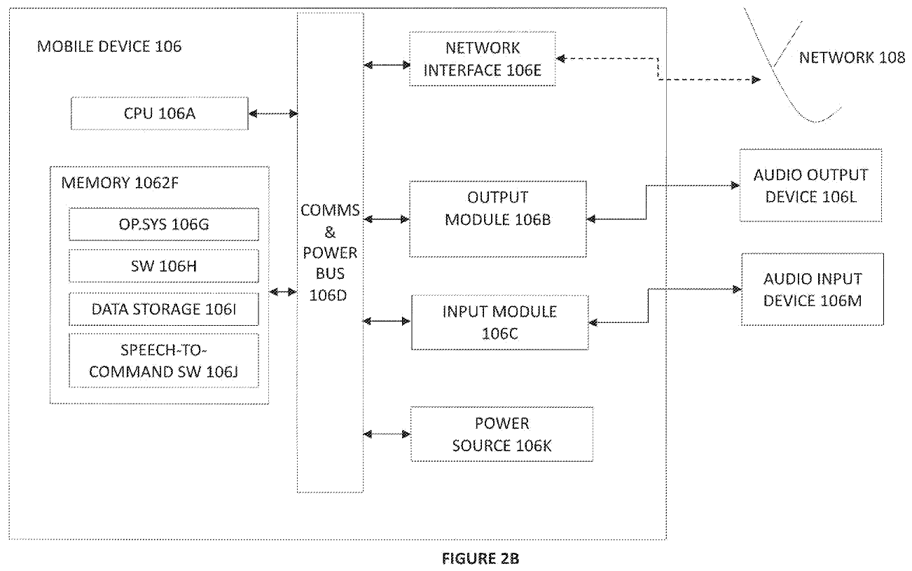

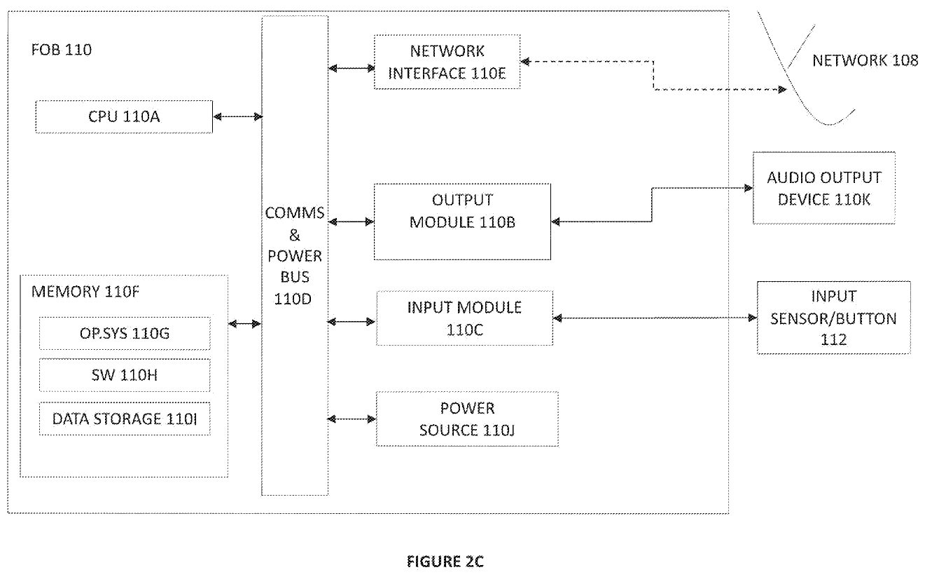

Referring now generally to the Figures, and particularly to FIG. 2A, FIG. 2A is a block diagram of the fixed device 102 of system 100 of FIG. 1 and displaying together both hardware and software aspects thereof, wherein the fixed device 102 comprises: a central processing unit or “CPU” 102A; an optional input module 102B such as for programming the fixed device 102 (the fixed device 102 might also alternatively be preprogrammed); an output module 102C; a communications & power bus 102D bi-directionally communicatively coupled with the CPU 102A, the input module 102B, the output module 102C; the communications & power bus 102D is further bi-directionally coupled with a network interface 102E, enabling communication with alternate computing devices by means of the network 108; and a memory 102F. The communications & power bus 102D facilitates communications between the above-mentioned components of the fixed device 102. The memory 102F of the fixed device 102 may include a software operating system OP.SYS 102G. The software operating system OP.SYS 102G of the fixed device 102 may be selected from freely available, open source and/or commercially available operating system software, such as but not limited to iOS 15.6.1 as provided on an iPhone 8 or iPad Pro as marketed by Apple Inc. of Cupertino, CA; Android 11 as provided on a Vivo X50 as marketed by Vivo Communication Technology Co. Ltd. of Dongguan, Guangdong, China; or another suitable electronic communications device operating system known in the art capable of enabling the fixed device 102 to perform networking and operating system services of the fixed device 102 as disclosed herein. Alternatively, the fixed device 102 may be manufactured as a configured logic board, with the functionality of the invented method encoded in hardware circuits. The exemplary software program SW 102H consisting of executable instructions and associated data structures is optionally adapted to enable the fixed device 102 to perform, execute and instantiate all elements, aspects and steps as required of the fixed device 102 to practice the invented method in its various preferred embodiments in interaction with other devices of the system 100. The memory 102F of the fixed device 102 may further include a volume for data storage 1021, and an interaction log 102J. The fixed device 102 further includes a power source 102K, providing electricity to other elements of the fixed device 102. It is noted that the power source 1021 might be a battery, or alternatively might be plugged in or wired into the electrical wiring of the building in which the fixed device 102 is installed. The fixed device 102 may further include an audio output device 102K, such as a speaker or other suitable means known in the art for generating audio sounds in accordance with the invented method as presented herein.

It is noted that the fixed device 102 may be a programmable device, but particularly in simpler implementations, is preferred to be a configured logic device, with all elements, aspects and steps as required of the fixed device 102 to practice the invented method in its various preferred embodiments in interaction with other devices of the system 100 instantiated as manufactured hardware circuits.

It is understood that the terms configured as defined in this disclosure includes the ranges of meaning as known in the art of programmed, reprogrammed, reconfigured, designed to, and adapted to.

The power source 102K may be or comprise a LITER-401230 X0030B99Y5 ™ battery as marketed by Amazon, Inc. of Bellevue, WA, or other suitable power source known in the art, including a hardwire landline connection to a power grid, in combination or in singularity. The audio output device 102K may be or comprise a piezoelectric buzzer 3V-24V Cylewet™ SFM-27 DC 3-24V as marketed by Amazon, Inc. of Bellevue, WA, and/or other suitable audio output device known in the art.

It is understood that the fixed device 102 may comprise a microcontroller module product that is BLUETOOTH and RFID wireless communications enabled, such as (1.) an ON Semiconductor NCH-RSL10-101Q48-ABG™ microcontroller manufactured by ON Semiconductor of Phoenix AZ, (2.) Nordic Semiconductor NRF52840-QIAA-R™ microcontroller manufactured by Nordic Semiconductor of Trondheim, Norway, (3.) a Texas Instruments CC2640R2FRGZR™ SimpleLink™ 32-bit Arm™ Cortex™-M3 Bluetooth™ 5.1 Low Energy wireless MCU with 128-kB flash microcontroller manufactured by Texas Instruments of Dallas, TX, (4.) an ESP32 Seeed Studio XIAO ESP32C3 B™ microcontroller as manufactured by Espressif Systems (Shanghai) Co., Ltd. Of Shanghai, Peoples Republic of China, in singularity or combination. Furthermore, when the fixed device 102 comprises a suitable microcontroller known in art as disclosed herein, said microcontroller may include the CPU 102A, the optional input module 102B; the communications & power bus 102D bi-directionally communicatively coupled with the CPU 102A, a wireless communications network interface 102E, and/or the memory 102F (5.) an Arduino Nano 33 IoT™ microcontroller and/or an Arduino Nano RP2040 Connect microcontroller manufactured by ARDUINO of Somerville, MA, USA, (6.) other suitable electronic communications and logic modules known in the art, in singularity, plurality or suitable combination.

The fixed device 102 is preferably located within 3 meters of the signage plate 104; more preferably attached to a same door as the signage plate 104; yet more preferably directly attached to the signage plate 104.

Referring now generally to the Figures, and particularly to FIG. 2B, FIG. 2B is a block diagram of the mobile device 106 of system 100 of FIG. 1 and displaying together both hardware and software aspects thereof, wherein the mobile device 106 comprises: a central processing unit or “CPU” 106A; an input module 106B; an output module 106C; a communications & power bus 106D bi-directionally communicatively coupled with the CPU 106A, the input module 106B, the output module 106C; the communications & power bus 106D is further bi-directionally coupled with a network interface 106E, enabling communication with alternate computing devices by means of the network 108; and a memory 106F. The communications & power bus 106D facilitates communications between the above-mentioned components of the mobile device 106. The memory 106F of the mobile device 106 includes a software operating system OP.SYS 106G. The software operating system OP.SYS 106G of the mobile device 106 may comprise or be selected from a freely available, open source and/or commercially available operating system software, such as but not limited to iOS as provided with an IPHONE 12 PRO MAX™ as marketed by Apple, Inc. of Cupertino, CA; Android 11 as provided on a Vivo X50 as marketed by Vivo Communication Technology Co. Ltd. of Dongguan, Guangdong, China; or other suitable electronic communications device operating system known in the art capable of enabling the mobile device 106 to perform networking and operating system services of the mobile device 106 as disclosed herein. The exemplary software program SW 106H consisting of executable instructions and associated data structures is optionally adapted to enable the mobile device 106 to perform, execute and instantiate all elements, aspects and steps as required of the mobile device 106 to practice the invented method in its various preferred embodiments in interaction with other devices of the system 100. The memory 106F may further include a volume of data storage 1061, and a speech-to-command software application 106J. The mobile device 106 may further include a power source 106K such as a device battery, an audio output device 106L, and an audio input device 106M such as a microphone. It is noted that the speech-to-command software application 106J and the audio input device 106M for operating the speech-to-command software application 106J are included particularly because an anticipated user may be visually impaired and may rely on these accessibility features for utilizing the mobile device 106 in the described context or any other. It is noted that other accessibility features may also be available on one's mobile phone, tablet, or other potential mobile device 106, besides speech-to-command.

Referring now generally to the Figures, and particularly to FIG. 2C, FIG. 2C is a block diagram of the fob 110 of the system 100 of FIG. 1 and displaying together both hardware and software aspects thereof, wherein the fob 110 comprises: a fob central processing unit or “CPU” 110A; a fob input module 110B; a fob output module 110C; a fob communications & power bus 110D bi-directionally communicatively coupled with the fob CPU 110A, the fob input module 110B, the fob output module 110C; the fob communications & power bus 110D is further bi-directionally coupled with a fob network interface 110E, enabling communication with alternate computing devices by means of the network 108; and a fob memory 110F. The fob communications & power bus 110D facilitates communications between the above-mentioned components of the fob 110. The fob memory 110F of the fob 110 may include a fob software operating system OP.SYS 110G. The fob software operating system OP.SYS 110G of the fob 110 may be selected from freely available, open source and/or commercially available operating system software, such as but not limited to iOS as provided with an IPHONE 12 PRO MAX™ as marketed by Apple, Inc. of Cupertino, CA; Android 11 as provided on a Vivo X50 as marketed by Vivo Communication Technology Co. Ltd. of Dongguan, Guangdong, China; or other suitable electronic communications device operating system known in the art capable of enabling the fob 110 to perform networking and operating system services of the fob 110 as disclosed herein. An exemplary software program fog SW 110H consisting of executable instructions and associated data structures is optionally adapted to enable the fob 110 to perform, execute and instantiate all elements, aspects and steps as required of the fob 110 to practice the invented method in its various preferred embodiments in interaction with other devices of the system 100. The fob memory 110F may further include a volume of fob data storage 1101. The fob 110 may further include a fob power source 110J, a fob audio output device 110K such as a speaker, and the input element 112 (such as a sensor or button) as presented also in FIG. 1. It is noted that the fob 110 may be a programmable device, but particularly in simpler implementations, is preferred to be a configured logic device, with all elements, aspects and steps as required of the fob 110 to practice the invented method in its various preferred embodiments in interaction with other devices of the system 100 instantiated as manufactured hardware circuits.

It is further noted that the fixed device 102, the mobile device 106, and/or the fob 110 may comprises wireless network interface 102E, 106E, 110E configured to send and/or receive wireless communications in accordance one or more electronic communications standards known in the art, including (1.) the BLUETOOTH™ short-range wireless technology provided by the BLUETOOTH SPECIAL INTEREST GROUP of Kirkland Washington; (2.) a Radio Frequency Identification (“RFID”) communications protocol RAIN RFID as regulated by the global standard EPC UHF Gen2v2 or ISO/IEC 18000-63 as promoted by the RAIN RFID Alliance of Wakefield, MA; (3.) one of the a family of wireless network protocols, based on the IEEE 802.11 promoted as a Wi-Fi™ wireless communications standard promoted by the non-profit Wi-Fi Alliance of Austin, TX; (4.) one or more other suitable Internet of Things compliant wireless electronic communications standards known in the art in combination or in singularity, (5.) one or more other suitable wireless electronic communications standards known in the art in combination or in singularity.

It is understood that the fob 110 may comprise a microcontroller module product that is BLUETOOTH and RFID wireless communications enabled, such as (1.) an ON Semiconductor NCH-RSL10-101Q48-ABG™ microcontroller manufactured by ON Semiconductor of Phoenix AZ, (2.) Nordic Semiconductor NRF52840-QIAA-R™ microcontroller manufactured by Nordic Semiconductor of Trondheim, Norway, (3.) a Texas Instruments CC2640R2FRGZR™ SimpleLink™ 32-bit Arm™ Cortex™-M3 Bluetooth™ 5.1 Low Energy wireless MCU with 128-kB flash microcontroller manufactured by Texas Instruments of Dallas, TX, and/or (4.) and/or (4.) ESP32 Seeed Studio XIAO ESP32C3 B™ microcontroller as manufactured by Espressif Systems (Shanghai) Co., Ltd. Of Shanghai, Peoples Republic of China, in singularity or combination. Furthermore, when the fob 110 comprises a suitable microcontroller known in art as described above, said microcontroller may comprise the fob CPU 110A, the optional fob input module 102B; the fob communications & power bus 102D bi-directionally communicatively coupled with the fob CPU 102A, the fob wireless communications network interface 102E, and/or the fob memory 102F.

The fob power source 106K may be or comprise a LITER Battery LITER-401230 X0030B99Y5 ™ battery, or other suitable power source known in the art.

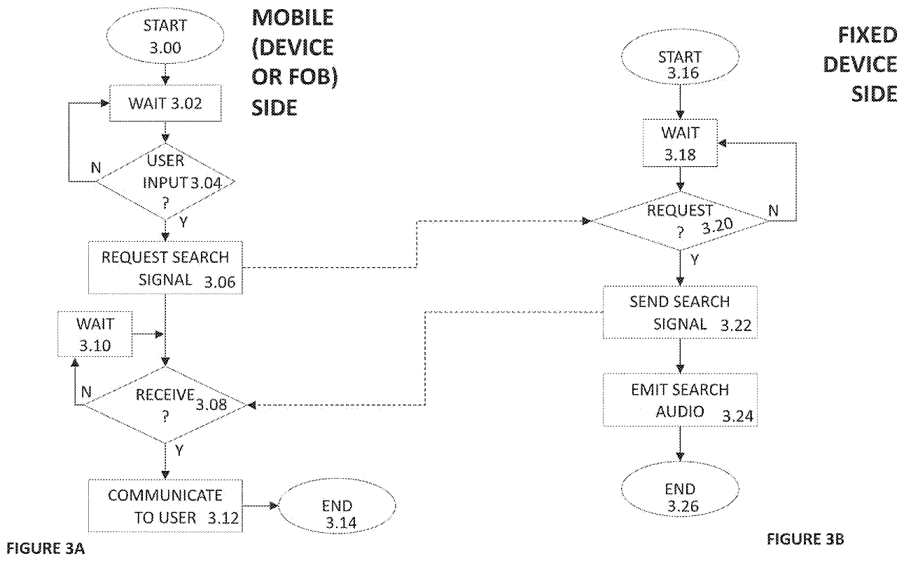

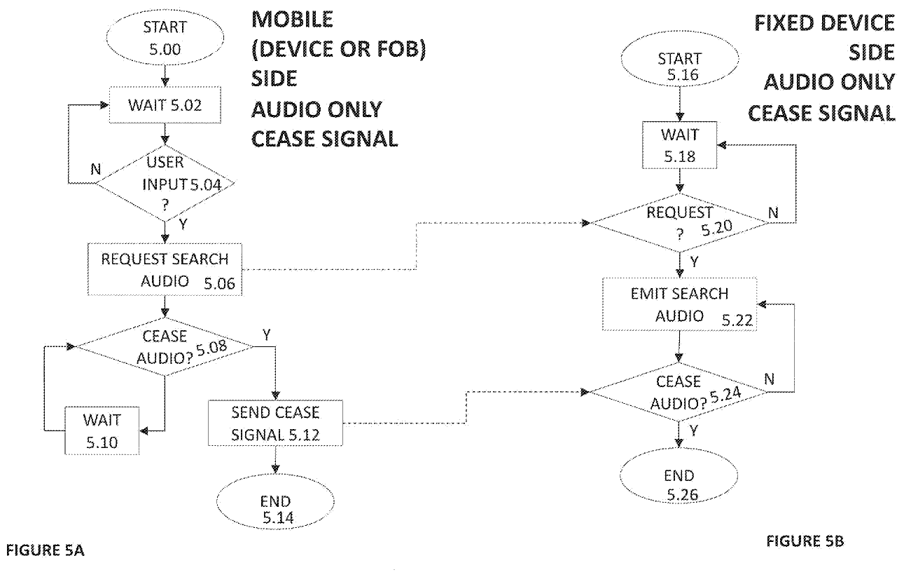

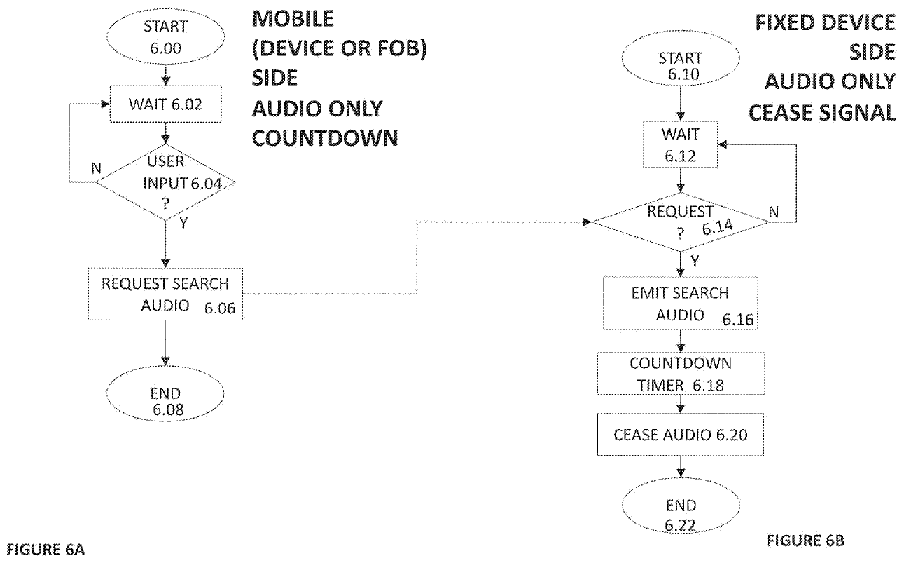

Referring now generally to the Figures, and particularly to FIG. 3A, FIG. 3A is a flow chart presenting in combination with FIG. 3B a first version of an invented method, from the mobile device 106 or the fob 110 (user) side. In this variation of the invented process, the user's device sends a request and expects a response back, and the fixed device 102 responds to the user's device and also emits audio. At step 3.00, the process starts. In step 3.02, user input is awaited. In step 3.04, it is determined whether user input has been received. If not, the wait continues. If so, at step 3.06, a search signal is requested. It is noted that this flow chart assumes, for the sake of simplicity, that the user input received is relevant to practicing the invented method, rather than some other unrelated process; specifically, that the user provides input indicating that the user is attempting to locate the amenity (for example, a restroom, as presented in FIG. 1) associated with the sign the fixed device 102 is associated with and would like assistance. (It is noted that this is the same kind of request awaited in step 3.20 of FIG. 3B, and this is a point at which the flow charts of FIG. 3A and FIG. 3B connect, as shown with the dotted arrow passing between these steps.) In step 3.08, it is determined whether a response has been received to the request sent in step 3.06, if any is expected (compare to the flow charts of FIGS. 5A and 6A). If not, in step 3.10, a response is waited for in a loop until received. (It is noted that this is the response sent in step 3.22 of FIG. 3B, and this is a point at which the flow charts of FIG. 3A and FIG. 3B connect, as shown with the dotted arrow passing between these steps.) Once a response is received, the response is communicated to the user in step 3.12. It is noted that such a response might include a recording of a sound to listen for which is also being emitted by the fixed device 102, or some other useful information for locating the sign, such as location information the mobile device 106 can use, or a text description (which a visually-impaired user's mobile device 106 might read aloud or otherwise present in a manner accessible to that user) containing directions (e.g. ‘to the left of the bottom of the staircase’), which might assist the user in locating the amenity associated with the fixed device 102. The process ends at step 3.14.

Referring now generally to the Figures, and particularly to FIG. 3B, FIG. 3B is a flow chart presenting in combination with FIG. 3A a first version of an invented method, from the fixed device (sign) side. In this variation of the invented process, the user's device sends a request and expects a response back, and the fixed device 102 responds to the user's device and also emits audio. The process starts at step 3.16. At step 3.18, the fixed device 102 awaits a request for assistance in approaching the location at which fixed device 102 is installed. In step 3.20, it is determined whether a request has been received; if not, the wait continues. If so, then the request is responded to, in the form of (a.) sending back a response to the requesting device at step 3.22; and (b.) emitting an audio sound at step 3.24 to assist in approaching the location at which fixed device 102 is installed. The process ends at step 3.26.

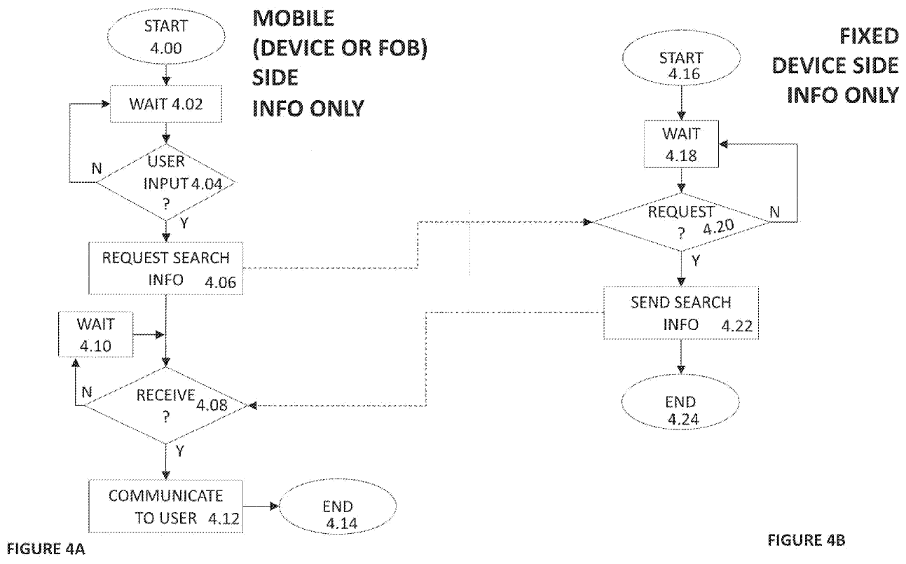

Referring now generally to the Figures, and particularly to FIG. 4A, FIG. 4A is a flow chart presenting in combination with FIG. 4B a second version of an invented method, from the mobile device 106 or the fob 110 (user) side. In this variation of the invented process, the user's device sends a request and expects a response back, and the fixed device 102 responds to the user's device but doesn't emit audio. At step 4.00, the process starts. In step 4.02, user input is awaited. In step 4.04, it is determined whether user input has been received. If not, the wait continues. If so, at step 4.06, a search signal is requested. It is noted that this flow chart assumes, for the sake of simplicity, that the user input received is relevant to practicing the invented method, rather than some other unrelated process; specifically, that the user provides input indicating that the user is attempting to locate the amenity (for example, a restroom, as presented in FIG. 1) associated with the sign the fixed device 102 is associated with and would like assistance. (It is noted that this is the same kind of request awaited in step 4.20 of FIG. 4B, and this is a point at which the flow charts of FIG. 4A and FIG. 4B connect, as shown with the dotted arrow passing between these steps.) In step 4.08, it is determined whether a response has been received to the request sent in step 4.06, if any is expected (compare to the flow charts of FIGS. 5A and 6A). If not, in step 4.10, a response is waited for in a loop until received. (It is noted that this is the response sent in step 4.22 of FIG. 4B, and this is a point at which the flow charts of FIG. 4A and FIG. 4B connect, as shown with the dotted arrow passing between these steps.) Once a response is received, the response is communicated to the user in step 4.12. It is noted that such a response might include a recording of a sound to listen for which is also being emitted by the fixed device 102, or some other useful information for locating the sign, such as location information the mobile device 106 can use, or a text description (which a visually-impaired user's mobile device 106 might read aloud or otherwise present in a manner accessible to that user) containing directions (e.g. ‘to the left of the bottom of the staircase’), which might assist the user in locating the amenity associated with the fixed device 102. The process ends at step 4.14.

Referring now generally to the Figures, and particularly to FIG. 4B, FIG. 4B is a flow chart presenting in combination with FIG. 4A a second version of an invented method, from the fixed device 102 (sign) side. In this variation of the invented process, the user's device sends a request and expects a response back, and the fixed device 102 responds to the user's device but doesn't emit audio. The process starts at step 4.16. At step 4.18, the fixed device 102 awaits a request for assistance in approaching the location at which fixed device 102 is installed. In step 4.20, it is determined whether a request has been received; if not, the wait continues. If so, then the request is responded to, in the form of sending back a response to the requesting device at step 4.22 to assist in approaching the location at which fixed device 102 is installed. The process ends at step 4.24.

Referring now generally to the Figures, and particularly to FIG. 5A, FIG. 5A is a flow chart presenting in combination with FIG. 5B a third version of an invented method, from the mobile device 106 or the fob 110 (user) side. In this variation of the invented process, the user's device sends a request and doesn't expect a response back, and the fixed device 102 responds to the user's device by emitting audio until the user's device sends a second signal to stop the audio. At step 5.00, the process starts. In step 5.02, user input is awaited. In step 5.04, it is determined whether user input has been received. If not, the wait continues. If so, at step 5.06, a search signal is requested. It is noted that this flow chart assumes, for the sake of simplicity, that the user input received is relevant to practicing the invented method, rather than some other unrelated process; specifically, that the user provides input indicating that the user is attempting to locate the amenity (for example, a restroom, as presented in FIG. 1) associated with the sign the fixed device 102 is associated with and would like assistance. (It is noted that this is the same kind of request awaited in step 5.20 of FIG. 5B, and this is a point at which the flow charts of FIG. 5A and FIG. 5B connect, as shown with the dotted arrow passing between these steps.) At step 5.08, it is determined whether to stop the audio which the fixed device 102 has begun to play in response to the request (see steps 5.20 and 5.22). If not, then wait at step 5.10. If so, a signal to cease the audio is sent to the fixed device 102 is sent at step 5.12, and the process ends at step 5.14.

Referring now generally to the Figures, and particularly to FIG. 5B, FIG. 5B is a flow chart presenting in combination with FIG. 5A a third version of an invented method, from the fixed device 102 (sign) side. In this variation of the invented process, the user's device sends a request and doesn't expect a response back, and the fixed device 102 responds to the user's device by emitting audio until the user's device sends a second signal to stop the audio. The process starts at step 5.16. At step 5.18, the fixed device 102 awaits a request for assistance in approaching the location at which fixed device 102 is installed. In step 5.20, it is determined whether a request has been received; if not, the wait continues. At step 5.22, once a request has been received, audio is played and continues (either as a single track or, if necessary, repeating) until it is determined at step 5.24 that a signal has been received to stop the audio. Once the signal is received, the audio is stopped and the process ends at step 5.26. It is noted that a further variation not presented in these flow charts combines features of multiple, such as a variation in which information is sent and audio is also looped.

Referring now generally to the Figures, and particularly to FIG. 6A, FIG. 6A is a flow chart presenting in combination with FIG. 6B a fourth version of an invented method, from the mobile device 106 or the fob 110 (user) side. In this variation of the invented process, the user's device sends a request and doesn't expect a response back, and the fixed device 102 responds to the user's device by emitting audio for a preset duration of time managed internally by the fixed device 102. At step 6.00, the process starts. In step 6.02, user input is awaited. In step 6.04, it is determined whether user input has been received. If not, the wait continues. If so, at step 6.06, a search audio cue is requested. It is noted that this flow chart assumes, for the sake of simplicity, that the user input received is relevant to practicing the invented method, rather than some other unrelated process; specifically, that the user provides input indicating that the user is attempting to locate the amenity (for example, a restroom, as presented in FIG. 1) associated with the sign the fixed device 102 is associated with and would like assistance. (It is noted that this is the same kind of request awaited in step 6.14 of FIG. 6B, and this is a point at which the flow charts of FIG. 6A and FIG. 6B connect, as shown with the dotted arrow passing between these steps.) The process ends at step 6.08.

Referring now generally to the Figures, and particularly to FIG. 6B, FIG. 6B is a flow chart presenting in combination with FIG. 6A a fourth version of an invented method, from the fixed device 102 (sign) side. In this variation of the invented process, the user's device sends a request and doesn't expect a response back, and the fixed device 102 responds to the user's device by emitting audio for a preset duration of time managed internally by the fixed device 102. The process starts at step 6.08. At step 6.12, the fixed device 102 awaits a request for assistance in approaching the location at which fixed device 102 is installed. In step 6.14, it is determined whether a request has been received; if not, the wait continues. At step 6.16, once a request has been received, audio is played. At step 6.18, a countdown timer is used to play the audio for a set duration of time. At step 6.20, after the countdown timer elapses, the audio stops. The process ends at step 6.22. It is noted that a further variation not presented in these flow charts combines features of multiple, such as a variation in which information is sent and audio is also continued for a specified duration.

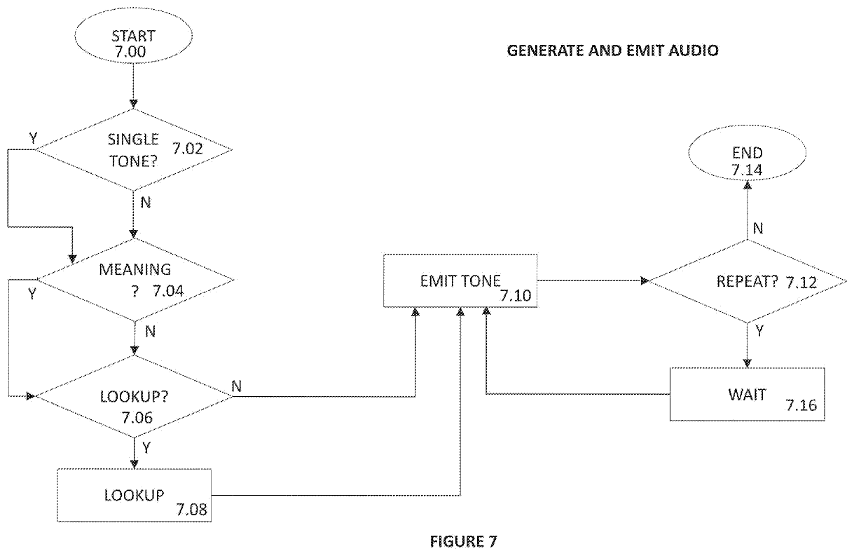

Referring now generally to the Figures, and particularly to FIG. 7, FIG. 7 is a flow chart presenting options for selection and production of an audio cue by the fixed device of FIG. 1, for use in practicing an invented method. At step 7.00, the process starts. At step 7.02, it is determined whether there is a single tone or audio item to be played (as opposed to a series or pattern). It is noted that this step is depicted to make it clear that this is a manner in which the audio may vary; both yes and no lead to the next question regardless because step 7.04 isn't contingent on step 7.02, these are just both ways in which audio can notably vary. In step 7.04, it is determined whether the audio to be played contains meaning; it is noted that, in a context where multiple instances of the fixed device 102 are utilized, it might be useful to differentiate and give the multiple instances distinct audio sounds, and make clear to users which one is which. If the sound means something, there may be a lookup required, determined at step 7.06, to ensure that the right audio tracks are used for the intended meaning, particularly if this embodiment is programmable or customizable. As an example of one way audio might be differentiated between different signage with minimal programming, one might consider an embodiment that emits morse code matching the signage text (for instance, the sign RESTROOM might play the following pattern of beeps with ‘-’ signifying a long beep and ‘•’ signifying a short beep: “•-• • ••• -”, translating to “REST” in morse code), such that the only programming required is the text content of the sign. In any case, if any lookup is required to select the right audio from multiple distinct options carrying different meanings, that processing is performed at step 7.08. At step 7.10, the selected audio, whatever that audio is, is played. At step 7.12, it is determined whether to repeat the played audio, such as for instance in accordance with the flow chart of FIG. 5B. If not, the process ends at step 7.14. If so, there might be a pause or interval at step 7.16 (or the delay may be 0 seconds), before the audio is repeated.

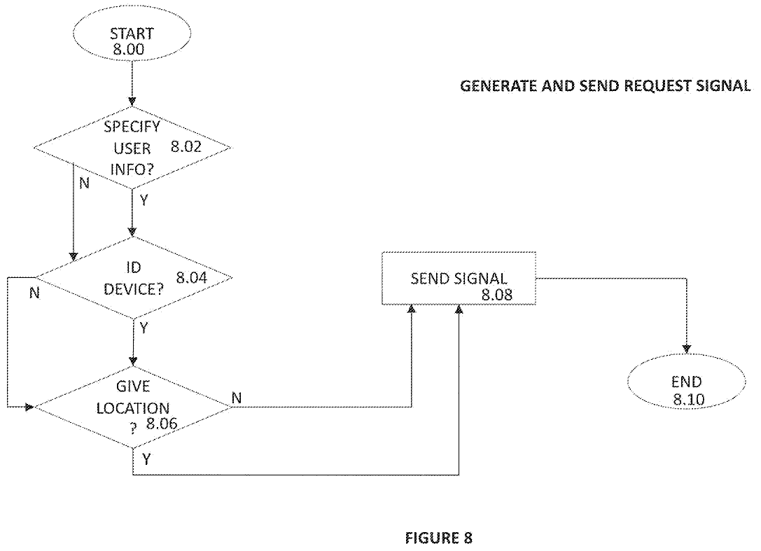

Referring now generally to the Figures, and particularly to FIG. 8, FIG. 8 is a flow chart presenting options for composition and sending of a request signal by the mobile device of FIG. 1, for use in practicing an invented method. At step 8.00, the process starts. At step 8.02, it is determined whether to specify information about the user in searching for the sign; for instance, if a restroom is being sought, the user's gender might be a relevant piece of information to specify for improved convenience. Regardless of whether user information is being specified, at step 8.04 it is determined whether information about the requested device, such as a unique identifier for use in further interactions, is being provided. Regardless, in step 8.06, it is determined whether the location of the mobile device 106 (and thus the user) is being provided. Once it has been determined what information is being provided, at step 8.08, a search signal is sent. The process ends at step 8.10.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

We claim:

1. A system comprising:
a. a fixed device comprising a control logic communicatively coupled with a fixed wireless communications module, an audio emitter, and a power source, the power source coupled with and providing electrical power to the control logic, the fixed wireless communications module and the audio emitter;
b. the fixed device coupled with a signage plate;
c. the signage plate visually signifying a physical resource, and the signage plate positioning the fixed device;
d. a mobile device comprising a mobile control logic communicatively coupled with a mobile wireless communications module and a user input module and a battery, the battery providing electrical power to the mobile control logic, the mobile wireless communications module and the user input module, wherein the control logic is configured to emit a search signal via the mobile wireless communications module upon detection by the user input module of a user search command; and
e. the fixed device is configured to emit an audible output via the audio emitter upon detection of the search signal.

2. The system of claim 1, wherein the fixed device is configured to repeatedly emit the audible output via the audio emitter upon detection of the search signal.

3. The system of claim 1, wherein the audible output is a single tone pattern.

4. The system of claim 1, wherein the audible output comprises an audible tone pattern that comprises at least two distinguishable tones.

5. The system of claim 2, wherein the audible tone pattern is associated with a pre-established meaning.

6. The system of claim 1, wherein the audible output comprises a plurality of audible tone patterns.

7. The system of claim 2, wherein each audible tone pattern of the plurality of audible tone patterns is separately associated with a distinguishable pre-established meaning.

8. The system of claim 1, further comprising:
a. the mobile device control logic further configured to emit a cessation signal via the mobile wireless communications module upon detection by the user input module of a sound cessation input command; and
b. the fixed device further configured to cease emitting the audible output upon receipt of the cessation signal.

9. The system of claim 1, the fixed device further comprising a countdown timer coupled with the control logic, and the control logic is further configured to initiate the countdown timer process upon receipt of the search signal and to cease emitting the audible signal upon a completion of the countdown timer process.

10. The system of claim 1, wherein the audible output is associated with an aspect of the physical resource.

11. The system of claim 1, wherein the mobile device further comprises a mobile audio output coupled with the control device and the mobile audio output is configured to emit a local audible output matching the audible output of the fixed device.

12. The system of claim 1, wherein the audible output comprises at least two successive and distinguishable sounds.

13. The system of claim 1, wherein the physical resource comprises at least one lavatory fixture.

14. The system of claim 1, wherein the signage plate presents a pattern of raised dots that are scaled, sized and positioned to be felt by human fingertips.

15. The system of claim 1, wherein the signage plate presents a pattern of raised dots that conform to aspects of a braille system of written language.

16. The system of claim 1, wherein audible output is emitted within a sound intensity range of from 20 decibels to 120 decibels.

17. The system of claim 1, wherein the user input module is adapted to detect and execute a verbal search instruction command.

18. The system of claim 1, wherein the user input module is adapted to detect and execute at least two verbal search instruction commands, wherein each verbal search command is formed in a separate and distinguishable human language.

19. The system of claim 1, wherein the user input module comprises a touch sensor adapted to detect and execute a search instruction command indicated by finger pressure.

20. The system of claim 1, wherein the user input module comprises a touch sensor adapted to detect and execute a search instruction command indicated by human body heat.

21. The system of claim 1, wherein the search signal includes information associated with the mobile device.

22. The system of claim 1, wherein the search signal includes information associated with a user of the mobile device.

23. The system of claim 1, wherein the search signal includes an identifier that directs a selection by the fixed device of the audible output.

24. The system of claim 1, wherein the fixed device includes a memory element coupled with the controller and the controller is further configured to record an aspect of an interaction with the mobile device.

25. The system of claim 1, wherein the fixed device includes a programmable memory element bidirectionally communicatively coupled with the controller and the controller is to receive reprogramming instructions via the wireless communications module and store the reprogramming instructions in the programmable memory, whereby the fixed device is reprogrammed.

26. The system of claim 1, wherein the mobile device user input module further comprises:
a microphone; and
speech-to-command logic coupled with the microphone and the mobile control logic, wherein the speech-to-command logic is configured derive of machine-executable commands from audio signals generated by the microphone and deliver the derived machine-executable commands to the mobile control logic.

27. The system of claim 26, wherein the mobile device user input is further communicatively coupled with the mobile wireless communications module, and the speech-to-command logic is further configured to communicate audio signals received via the microphone to a remote server via the mobile wireless communications module, and the mobile device user is further configured receive at least one derived machine-executable command via the mobile wireless communications module and to deliver the at least one derived machine-executable command to the mobile control logic.

28. The system of claim 1, further comprising:
a server comprising a remote speech-to-command logic, the speech-to-command logic configured to derive machine-executable commands from audio signals;
a microphone coupled with the mobile control logic; and
the mobile device user input is coupled with a speech-to-command logic and the microphone, wherein the mobile device user input is further communicatively coupled with the mobile wireless communications module, and the speech-to-command logic is further configured to communicate audio signals received from the microphone to the remote server via the mobile wireless communications module, and the mobile device user is further configured receive at least one derived machine-executable command via the mobile wireless communications module from the remote server and to deliver the at least one derived machine-executable command to the mobile control logic.

29. A method comprising:
a. positioning a fixed device coupled with a signage plate relative to a physical resource, the fixed device comprising a control logic communicatively coupled with a fixed wireless communications module and an audio emitter, and a power source, the power source coupled with and providing electrical power to the control logic, the fixed wireless communications module and the audio emitter;
b. fixed device detecting a preset search signal received via the fixed wireless communications module; and
c. the fixed device thereupon emitting an audible output upon receipt preset search signal, wherein the audible output indicates an aspect of the physical resource.
